(19) United States
(12) Patent Application Publication
(10) Pub. No.: US 2025/0155850 A1
(43) Pub. Date: May 15, 2025

(54) APPARATUS, METHOD, AND PROCESSOR FOR CHANGING UNDERWATER DEVICE OPERATION

(71) Applicant: Lenovo (Singapore) Pte. Ltd., New Tech Park (SG)

(72) Inventors: Scott Li, Cary, NC (US); Igor Stolbikov, Apex, NC (US); Robert J. Kapinos, Durham, NC (US)

(21) Appl. No.: 18/508,681

(22) Filed: Nov. 14, 2023

(51) Int. Cl. G04G 99/00; B63C 11/02; G01C 5/06; G04G 17/04; G04G 21/02

(52) U.S. Cl. CPC G04G 99/006; G01C 5/06; G04G 17/04; G04G 21/02; B63C 2011/021

(57) ABSTRACT

Apparatuses, methods, and program products are disclosed for changing underwater device operation. One apparatus includes a sensor, at least one memory, and at least one processor coupled with the at least one memory and configured to cause the apparatus to: receive, by use of the sensor, data corresponding to an environmental factor; determine whether the data indicates that the apparatus is underwater; and, in response to the data indicating that the apparatus is underwater, change operation of the apparatus.

### BACKGROUND

### Field

The subject matter disclosed herein relates to information handling devices and more particularly relates to changing underwater device operation.

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for performing various actions, such as tracking health related data. Certain devices, such as smart watches, may not operate as desired while underwater.

### BRIEF SUMMARY

An apparatus for changing underwater device operation is disclosed. A method and processor also perform the functions of the apparatus. In one embodiment, the apparatus includes a sensor, at least one memory, and at least one processor coupled with the at least one memory and configured to cause the apparatus to: receive, by use of the sensor, data corresponding to an environmental factor; determine whether the data indicates that the apparatus is underwater; and, in response to the data indicating that the apparatus is underwater, change operation of the apparatus.

In some embodiments, the apparatus includes a smart watch. In one embodiment, the sensor includes a barometric pressure sensor. In various embodiments, the data indicates that the apparatus is underwater in response to a measured barometric pressure passing a threshold rate of change. In some embodiments, changing the operation of the apparatus includes disabling a feature of the apparatus, enabling a feature of the apparatus, or a combination thereof.

A method for changing underwater device operation, in one embodiment, includes receiving, by use of a sensor of an apparatus, data corresponding to an environmental factor. In certain embodiments, the method includes determining, by use of at least one processor of the apparatus, whether the data indicates that the apparatus is underwater. In some embodiments, the method includes, in response to the data indicating that the apparatus is underwater, changing operation of the apparatus.

In some embodiments, the apparatus includes a smart watch. In various embodiments, the sensor includes a barometric pressure sensor. In one embodiment, the data includes barometric pressor data. In some embodiments, the environmental factor includes barometric pressure. In certain embodiments, the data indicates that the apparatus is underwater in response to a measured barometric pressure passing a threshold value.

In some embodiments, the data indicates that the apparatus is underwater in response to a measured barometric pressure passing a threshold rate of change. In various embodiments, changing the operation of the apparatus includes disabling a feature of the apparatus, enabling a feature of the apparatus, or a combination thereof. In certain embodiments, disabling a feature of the apparatus includes disabling a touch screen of the apparatus. In some embodiments, enabling a feature of the apparatus includes enabling an underwater function of the apparatus. In various embodiments, the underwater function of the apparatus includes a swim mode of the apparatus. In certain embodiments, determining whether the data indicates that the apparatus is underwater includes detecting whether a measurement of the sensor is outside of a predetermined set of measurements.

In one embodiment, a processor includes at least one controller coupled with at least one memory and configured to cause the processor to: receive, by use of a sensor, data corresponding to an environmental factor; determine whether the data indicates that the processor is underwater; and, in response to the data indicating that the processor is underwater, changing operation of the processor.

In certain embodiments, the sensor includes a barometric pressure sensor. In one embodiment, the data indicates that the processor is underwater in response to a measured barometric pressure passing a threshold rate of change.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for changing underwater device operation;

FIG. 2 is a schematic block diagram illustrating one embodiment of an apparatus including an information handling device;

FIG. 3 is a schematic block diagram illustrating one embodiment of an apparatus including an underwater operation change module;

FIG. 4 is a schematic block diagram illustrating one embodiment of an apparatus that uses an underwater operation change module;

FIG. 5 is a schematic block diagram illustrating one embodiment of a display using an underwater operation change module; and

FIG. 6 is a schematic flow chart diagram illustrating an embodiment of a method for changing underwater device operation.

### DETAILED DESCRIPTION

As will be appreciated by one skilled in the art, aspects of the embodiments may be embodied as a system, apparatus, method, processor, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be used. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, processors, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to one or more processors of a general purpose computer, special purpose computer, or other programmable data processing apparatus to produce a machine, such that the instructions, which execute via the one or more processors of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

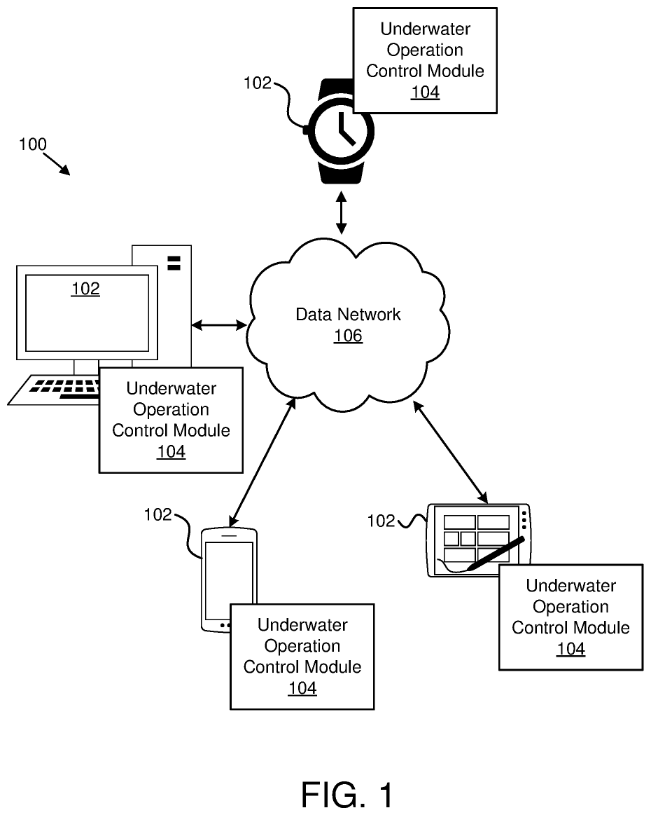

FIG. 1 depicts one embodiment of a system 100 for changing underwater device operation. In one embodiment, the system 100 includes information handling devices 102, underwater operation change modules 104, and data networks 106. Even though a specific number of information handling devices 102, underwater operation change modules 104, and data networks 106 are depicted in FIG. 1, one of skill in the art will recognize that any number of information handling devices 102, underwater operation change modules 104, and data networks 106 may be included in the system 100.

In one embodiment, the information handling devices 102 include computing devices, such as desktop computers, laptop computers, personal digital assistants (PDAs), tablet computers, smart phones, cellular phones, smart televisions (e.g., televisions connected to the Internet), set-top boxes, game consoles, security systems (including security cameras), vehicle on-board computers, network devices (e.g., routers, switches, modems), streaming devices, digital assistants (e.g., public digital assistants), or the like that may include one or more image capturing devices (e.g., video cameras, cameras). In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the underwater operation change module 104. In certain embodiments, the underwater operation change module 104 may receive, by use of a sensor of an apparatus, data corresponding to an environmental factor. The underwater operation change module 104 may also determine whether the data indicates that the apparatus is underwater. The underwater operation change module 104 may, in response to the data indicating that the apparatus is underwater, change operation of the apparatus. In this manner, the underwater operation change module 104 may be used for changing underwater device operation.

The data network 106, in one embodiment, includes a digital communication network that transmits digital communications. The data network 106 may include a wireless network, such as a wireless cellular network, a local wireless network, such as a Wi-Fi network, a Bluetooth® network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

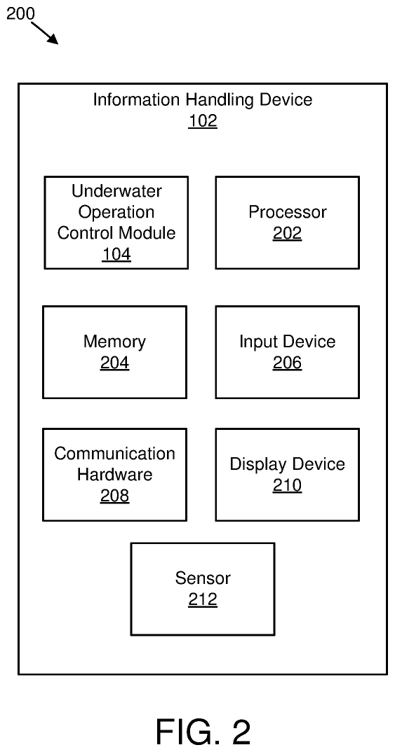

FIG. 2 depicts one embodiment of an apparatus 200 that may be used for changing underwater device operation. The apparatus 200 includes one embodiment of the information handling device 102. Furthermore, the information handling device 102 may include the underwater operation change module 104, a processor 202, a memory 204, an input device 206, communication hardware 208, optionally a display device 210, and a sensor 212. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the underwater operation change module 104, the input device 206, the communication hardware 208, the display device 210, and the sensor 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores configuration information. In some embodiments, the memory 204 also stores program code and related data, such as an operating system or other controller algorithms operating on the information handling device 102.

The information handling device 102 may use the underwater operation change module 104 for changing underwater device operation. As may be appreciated, the underwater operation change module 104 may include computer hardware, computer software, or a combination of both computer hardware and computer software. For example, the underwater operation change module 104 may include circuitry, or the processor 202, used to receive, by use of the sensor 212, data corresponding to an environmental factor (of the information handling device 102). As another example, the underwater operation change module 104 may include computer program code that determines whether the data indicates that the information handling device 102 is underwater. As a further example, the underwater operation change module 104 may include computer program code that, in response to the data indicating that the information handling device 102 is underwater, changes operation of the information handling device 102.

The input device 206, in one embodiment, may include any known computer input device including a touch panel, a button, a keyboard, a stylus, a microphone for receiving audio input (e.g., or another audio input device for receiving audio input), an image capturing device, a camera, a video camera, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the underwater operation change module 104.

In certain embodiments, the sensor 212 may detect a change in a measurement indicative of the information handling device 102 changing from being out of water to being underwater. Specifically, the sensor 212 may be used to detect water submersion and/or may trigger specific actions to enhance user experience of a user of the information handling device 102.

The sensor 212 may be a barometric sensor, a pressure sensor, a voltage sensor, a stress sensor, or any other type of suitable sensor. For example, the sensor 212 may be a micro electronic mechanical system (“MEMS”) barometric pressure sensor. A MEMS barometric sensor may be constructed with a mono-silicon micro-sized membrane. In the MEMS barometric sensor, intrinsic mechanical stoppers may inhibit breakages caused by excess pressure, thereby enabling measurement repeatability. A pressure inside of the MEMs barometric sensor may be constant and/or controlled by various processor parameters. Moreover, the MEMS barometric sensor may be calibrated for temperature and/or air pressure.

The sensor 212 may be calibrated properly for the type of measurement that is to be made. For example, if the sensor 212 is a barometric sensor it may be calibrated for atmospheric pressure so that it can accurately register air pressure or height from sea level.

In various systems, water submersion of the information handling device 102 (e.g., a smartwatch) may result in unwanted touch events, which may be a problem for users. As may be appreciated, when certain information handling devices 102 are submerged in water, a touchscreen may become active and may register accidental inputs, such as taps and/or swipes. The taps and/or swipes may result in unintended actions, such as changing music (e.g., turning on, turning off, changing a volume), changing alarms (e.g., setting, removing, changing times), and/or making phone calls. It should be noted that unwanted touch events may cause frustration and/or inconvenience to users (e.g., the user may be unable to access features or information due to accidental inputs).

In certain embodiments, the information handling device 102 may use the sensor 212 to determine when the information handling device 102 is underwater, then the information handling device 102 may disable features (e.g., touchscreen) to inhibit unwanted events from occurring.

As may be appreciated, the sensor 212, if it is a barometric sensor, may not register water pressure accurately, but water submersion may induce voltage swings which can be used to trigger action to enhance user experience (e.g., make setting changes if the voltage swings caused by water submersion are detected). In some systems, the sensor 212 continuously monitors atmospheric pressure and detects changes in pressure when the device is submerged in water. Once the submersion is detected, the information handling device 102 disables a touchscreen of the information handling device 102 to inhibit accidental inputs and/or to protect the information handling device 102 from water damage. In certain systems, the information handling device 102 is set to a water mode (e.g., swim mode) upon determining that the information handling device 102 is underwater, where specific features and tracking modes are activated to enhance the user's experience.

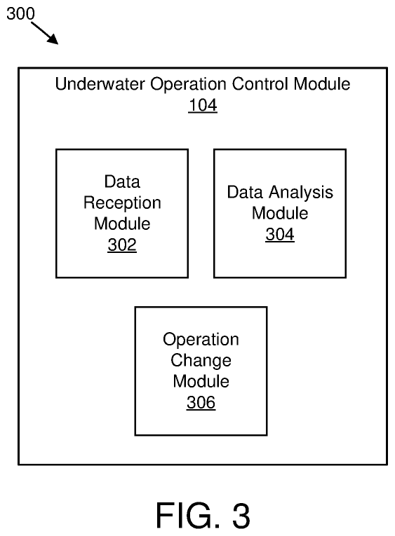

FIG. 3 depicts a schematic block diagram illustrating one embodiment of an apparatus 300 (e.g., information handling device 102) that includes one embodiment of the underwater operation change module 104. Furthermore, the underwater operation change module 104 includes a data reception module 302, a data analysis module 304, and an operation change module 306. The underwater operation change module 104 may be used to change operations of the apparatus 300 in response to determining that the apparatus 300 is underwater.

In certain embodiments, the data reception module 302 may receive, by use of a sensor (e.g., sensor 212) of the apparatus 300, data corresponding to an environmental factor. The apparatus 300 may be a smart watch, or some other activity tracker worn by a user. Moreover, the sensor may be a barometric pressure sensor, or any other suitable sensor. Further, the data may include any type of data measured by the sensor that indicates that the apparatus 300 is underwater (e.g., barometric pressor data, temperature data from a temperature sensor, voltage data, humidity measured by a humidity sensor, light measured by a light sensor, images taken by a camera, and so forth). The environmental factor may be any type of factor caused by the environment that the apparatus 300 is in (e.g., barometric pressure, temperature, humidity, stress, light, and so forth).

In one embodiment, the data analysis module 304 may determine, by use of at least one processor of the apparatus 300, whether the data indicates that the apparatus 300 is underwater. The data may indicate that the apparatus 300 is underwater in response to a measured barometric pressure passing a threshold value, for example. As other examples, the data may indicate that the apparatus 300 is underwater in response to a humidity, a temperature, an amount of light, or another factor passing a threshold value. In one example, the data indicates that the apparatus 300 is underwater in response to a measured barometric pressure passing a threshold rate of change (e.g., the pressure changes at an abnormal rate, which may occur when the sensor moves from air to water). In some embodiments, determining whether the data indicates that the apparatus 300 is underwater includes detecting whether a measurement of the sensor is outside of a predetermined set of measurements. In one example, being outside of a predetermined set of measurements may be that the measurement received from a barometric sensor is not part of a table of normal voltage deltas and/or swings (e.g., voltage and/or pressure lookup table). Being outside of the predetermined set of measurements may trigger an indication that the apparatus 300 is underwater.

In various embodiments, the operation change module 306 may, in response to the data indicating that the apparatus 300 is underwater, change operation of the apparatus 300. In one example, changing the operation of the apparatus 300 includes disabling a feature of the apparatus, enabling a feature of the apparatus, or a combination thereof. Specifically, disabling a feature of the apparatus may include disabling a touch screen of the apparatus 300, disabling a mode of the apparatus 300, disabling features of the apparatus 300, disabling processes of the apparatus 300, and/or disabling processing of the apparatus 300. Moreover, enabling a feature of the apparatus 300 may include enabling an underwater function of the apparatus 300. The underwater function of the apparatus 300 may include a swim mode of the apparatus 300, a test mode of the apparatus 300, measuring a set of parameters corresponding to being underwater, measuring a quality of the water, measuring a chemical makeup of the water, and so forth.

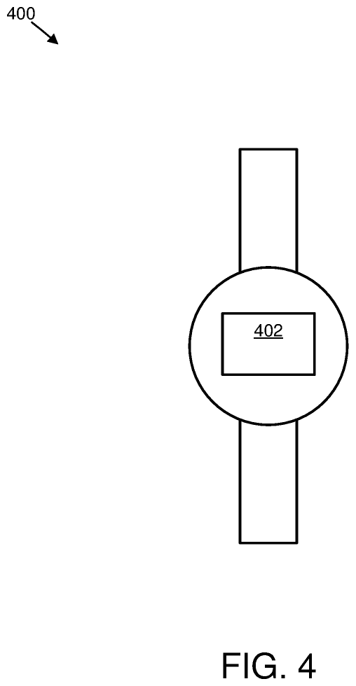

FIG. 4 is a schematic block diagram illustrating one embodiment of an apparatus 400 (e.g., smartwatch) that uses an underwater operation change module 102. The apparatus 400 is used by a user and includes a display 402 that may display any number of measured parameters, such as an altitude. As described herein, the underwater operation change module 102 coordinates with the apparatus 400 to change operation of the apparatus 400 depending on whether the apparatus 400 is underwater.

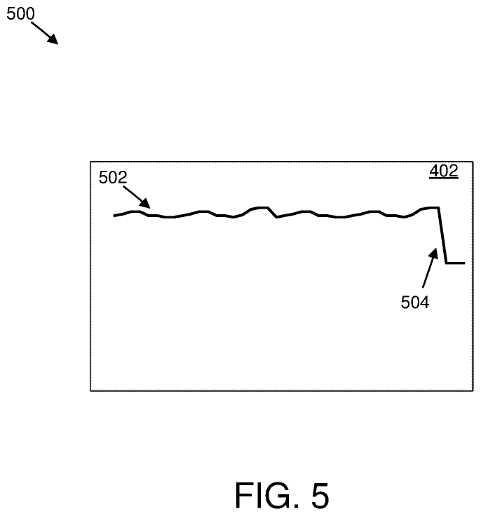

FIG. 5 is a schematic block diagram illustrating one embodiment of a display 500 (e.g., display 402) using an underwater operation change module 102. In this example, a sensor (e.g., sensor 212) may make measurements. Data corresponding to these measurements may be shown on the display 500. In one example, the sensor is a barometric pressure sensor, and an altitude 502 corresponding to measurements made by the sensor may be displayed. At a point in time 504, the altitude 502 may make a sudden drop. This rapid change in measured altitude may be caused by an apparatus having the display 500 going underwater. The change is not a result of the change in altitude, but a result of the sensor not accurately measuring the altitude. This inaccurate measuring can be used by the apparatus to indicate that the apparatus is underwater.

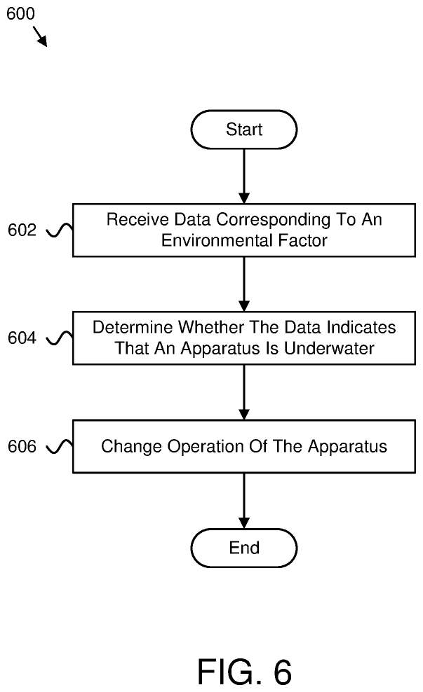

FIG. 6 is a schematic flow chart diagram illustrating an embodiment of a method 600 for changing underwater device operation. In some embodiments, the method 600 is performed by an apparatus, such as the information handling device 102. In other embodiments, the method 600 may be performed by a module, such as the underwater operation change module 104. In certain embodiments, the method 600 may be performed by a processor executing program code, for example, a microcontroller, a microprocessor, a CPU, a GPU, an auxiliary processing unit, a FPGA, or the like.

The method 600 may include receiving 602, by use of a sensor (e.g., the sensor 212) of an apparatus, data corresponding to an environmental factor. In certain embodiments, the data reception module 302 may receive 602 the data corresponding to an environmental factor. The method 600 may include determining 604, by use of at least one processor of the apparatus, whether the data indicates that the apparatus is underwater. In some embodiments, the data analysis module 304 may determine 604 whether the data indicates that the apparatus is underwater.

The method 600 may include, in response to the data indicating that the apparatus is underwater, changing 606 operation of the apparatus. In some embodiments, the operation change module 306 may change 606 operation of the apparatus.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a sensor;
at least one memory; and
at least one processor coupled with the at least one memory and configured to cause the apparatus to:
receive, by use of the sensor, data corresponding to an environmental factor;
determine whether the data indicates that the apparatus is underwater; and
in response to the data indicating that the apparatus is underwater, change operation of the apparatus.

2. The apparatus of claim 1, wherein the apparatus comprises a smart watch.

3. The apparatus of claim 1, wherein the sensor comprises a barometric pressure sensor.

4. The apparatus of claim 1, wherein the data indicates that the apparatus is underwater in response to a measured barometric pressure passing a threshold rate of change.

5. The apparatus of claim 1, wherein changing the operation of the apparatus comprises disabling a feature of the apparatus, enabling a feature of the apparatus, or a combination thereof.

6. A method comprising:
receiving, by use of a sensor of an apparatus, data corresponding to an environmental factor;
determining, by use of at least one processor of the apparatus, whether the data indicates that the apparatus is underwater; and
in response to the data indicating that the apparatus is underwater, changing operation of the apparatus.

7. The method of claim 6, wherein the apparatus comprises a smart watch.

8. The method of claim 6, wherein the sensor comprises a barometric pressure sensor.

9. The method of claim 6, wherein the data comprises barometric pressor data.

10. The method of claim 6, wherein the environmental factor comprises barometric pressure.

11. The method of claim 6, wherein the data indicates that the apparatus is underwater in response to a measured barometric pressure passing a threshold value.

12. The method of claim 6, wherein the data indicates that the apparatus is underwater in response to a measured barometric pressure passing a threshold rate of change.

13. The method of claim 6, wherein changing the operation of the apparatus comprises disabling a feature of the apparatus, enabling a feature of the apparatus, or a combination thereof.

14. The method of claim 13, wherein disabling a feature of the apparatus comprises disabling a touch screen of the apparatus.

15. The method of claim 13, wherein enabling a feature of the apparatus comprises enabling an underwater function of the apparatus.

16. The method of claim 15, wherein the underwater function of the apparatus comprises a swim mode of the apparatus.

17. The method of claim 6, wherein determining whether the data indicates that the apparatus is underwater comprises detecting whether a measurement of the sensor is outside of a predetermined set of measurements.

18. A processor, comprising:
at least one controller coupled with at least one memory and configured to cause the processor to:
receive, by use of a sensor, data corresponding to an environmental factor;
determine whether the data indicates that the processor is underwater; and
in response to the data indicating that the processor is underwater, changing operation of the processor.

19. The processor of claim 18, wherein the sensor comprises a barometric pressure sensor.

20. The processor of claim 18, wherein the data indicates that the processor is underwater in response to a measured barometric pressure passing a threshold rate of change.
